(19) United States
(12) Patent Application Publication
(10) Pub. No.: US 2011/0014953 A1
(43) Pub. Date: Jan. 20, 2011

(54) USER INPUT ASSEMBLY FOR AN ELECTRONIC DEVICE

(76) Inventor: Tsz Kan Mok, Hong Kong (HK)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 12/564,105

(22) Filed: Sep. 22, 2009

(30) Foreign Application Priority Data
Jul. 20, 2009 (CN) 200910165875.6

(51) Int. Cl. H04M 1/00

(52) U.S. Cl. 455/566; 345/173

(57) ABSTRACT

A touch sensitive user input assembly for enter characters into an electronic device. During a telephone mode, use of the input assembly may be made to enter telephone numbers by touching predetermined areas of the input assembly. During a text entry mode, the user may enter characters from a larger character set, including letters, numbers, symbols, emoticons, accent markings, or other characters. In this mode, the user may tap one of the predetermined areas to enter a character that has been previously associated with this action. The predetermined area also may be used to enter additional previously associated characters by touching the predefined area and then dragging in a predetermined direction to cycle through plural character choices. When a desired character is reached, the user may release his or her finger from the keypad to enter the desired character.

### TECHNICAL FIELD OF THE INVENTION

The technology of the present disclosure relates generally to electronic devices and, more particularly, to a system and method for entry of characters into an electronic device, such as a mobile telephone.

### BACKGROUND

Mobile telephones may be used to make calls and send messages, such as text messages and electronic mail messages. There are two common types of conventional keypads that may be used for the entry of English-based characters when composing a message. One style keypad includes one key for each letter of the English language. These keys also may be used for the entry of numbers and symbols. Due to the large number of keys, this style keypad tends to lead to small keys that are tightly spaced together.

The other style keypad has one key for each number zero through nine, plus a star key and a pound key (also referred to as a hash). The keys for the numbers two through nine are also associated with three or four letters. To enter letters, the user may press the corresponding number key to cycle through the associated letters until the desired letter is displayed. If the user attempts to enter two letters associated with the same key, the user may make key depressions to enter the first letter, wait a period of time, and then may key depressions to enter the second letter. The style keypad is often difficult and time consuming to use.

### SUMMARY

To enhance user interaction with an electronic device, the present disclosure describes a user input assembly and method of entering characters, including one or more or letters, numbers, symbols, emoticons, and so forth. The assembly includes a touch sensitive pad. In one embodiment, the input assembly is made part of a mobile telephone. During certain operational modes, use of the touch pad may be made to enter telephone numbers. For this purpose, there may be predefined areas of the touch pad that correspond to the numbers zero through nine and predefined areas that corresponding to the star symbol and the pound (or hash) symbol. During other operational modes, use of the touch pad may be made to enter characters from a larger character set, including letters, numbers, symbols, emoticons, accent markings, or other characters (e.g., characters from character-based languages, such as Chinese). In this mode, the user may touch and release (e.g., “tap”) one of the predefined areas to enter a character that has been previously associated with this action. The predefined area may be used to enter additional previously associated characters by touching the predefined area and then dragging in a predetermined direction to cycle through plural character choices. When a desired character is reached, the user may release his or her finger from the keypad to enter the desired character into a text entry field.

According to one aspect of the disclosure, an electronic device includes a touch sensitive user input assembly including plural predefined touch regions corresponding to numerical digits for entering digits of a telephone number while the electronic device is in a telephone mode, and in a text entry mode of the electronic device, each touch region is associated with a subset of characters from a character map so that touching and release of one of the touch regions results in entry of a first character from the associated subset of characters, and touching of the touch region followed by moving against the user input assembly results in scrolling through characters of the subset and a scrolled to one of the characters is entered in response to release of touching from the user input assembly.

According to one embodiment of the electronic device, there are ten touch regions corresponding to numbers zero through nine for the telephone mode.

According to one embodiment of the electronic device, the user input assembly further includes an additional touch region corresponding to a star character in the telephone mode and an additional touch region corresponding to a pound character in the telephone mode.

According to one embodiment of the electronic device, the touch regions are arranged in a circular arrangement.

According to one embodiment of the electronic device, the moving against the user input assembly includes clockwise movement to scroll through at least a portion of the subset of characters.

According to one embodiment of the electronic device, the moving against the user input assembly further includes counterclockwise movement to scroll through at least another portion of the subset of characters.

According to one embodiment of the electronic device, the subset of characters for at least one pad region includes characters that are configured as emoticons.

According to one embodiment of the electronic device, the touch sensitive user input assembly includes a touch pad.

According to one embodiment of the electronic device, the touch pad is arranged separately from a display of the electronic device.

According to one embodiment of the electronic device, in the text entry mode, an additional one of the touch regions shifts from a default upper or lower case for letter characters to the other of the upper or lower case.

According to one embodiment of the electronic device, an additional one of the touch regions corresponds to entry of a space character in the text entry mode.

According to one embodiment of the electronic device, the additional one of the touch regions corresponding to entry of a space character further corresponds to entry of at least one of a return, a backspace or a tab.

These and further features will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a schematic view of a mobile telephone as an exemplary electronic device that includes a user input assembly;

FIG. 2 is a schematic block diagram of the mobile telephone of FIG. 1;

FIG. 3 is a first exemplary character map for the input assembly; and

FIG. 4 is a second exemplary character map for the input assembly.

### DETAILED DESCRIPTION OF EMBODIMENTS

Embodiments will now be described with reference to the drawings, wherein like reference numerals are used to refer to like elements throughout. It will be understood that the figures are not necessarily to scale.

In the present document, embodiments are described primarily in the context of a portable radio communications device, such as the illustrated mobile telephone. It will be appreciated, however, that the exemplary context of a mobile telephone is not the only operational environment in which aspects of the disclosed systems and methods may be used. Therefore, the techniques described in this document may be applied to any type of appropriate electronic device, examples of which include a mobile telephone, a media player (e.g., an MP3 player), a gaming device, a computer, a pager, etc.

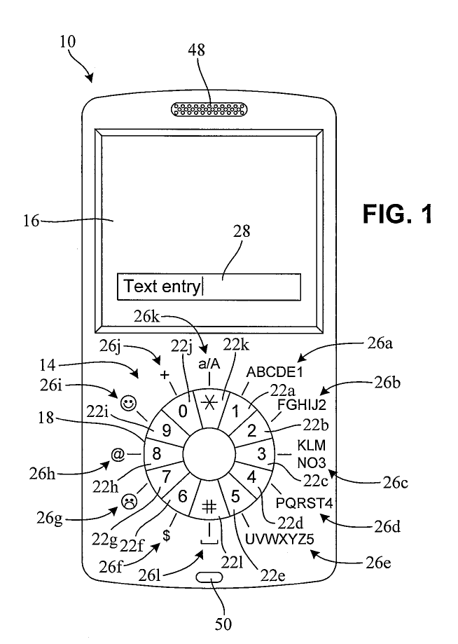

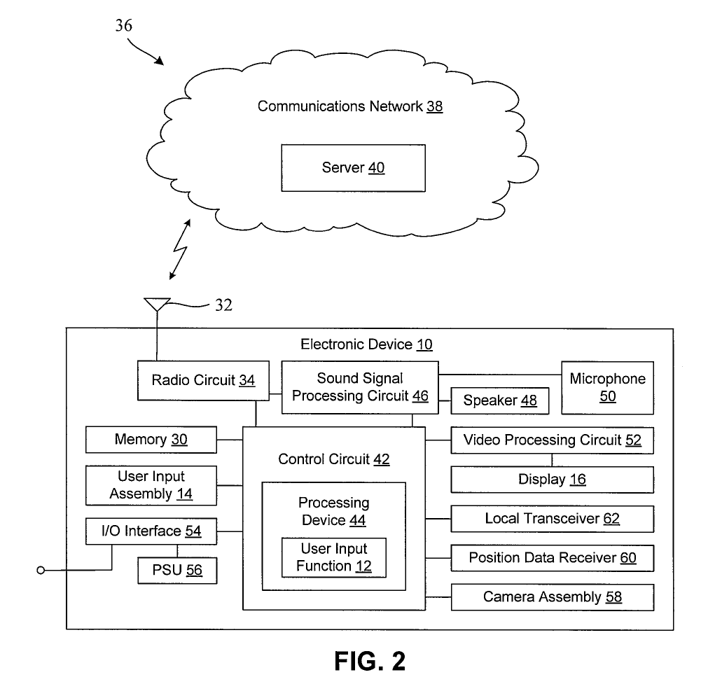

Referring initially to FIGS. 1 and 2, an electronic device 10 is shown. The electronic device 10 includes a user input function 12 that is configured to interpret user interaction with a user input assembly 14 and control the electronic device 10 in accordance with the interpreted user input. The user input function 12 may be configured to implement the user input functionality that is described in greater detail below. The user input function 12 may be embodied as executable instructions (e.g., code) that is resident in and executed by the electronic device 10. In one embodiment, the user input function 12 may be one or more programs that are stored on a computer readable medium. The user input function 12 may be a stand-alone software application or form a part of a software application that carries out additional tasks related to the electronic device 10.

The user input assembly 14 is configured to allow for a variety of user input operations. For example, characters used to generate alphanumeric information (e.g., telephone numbers, phone lists, contact information, notes, messages, text, etc.) may be entered with the user input assembly 14. The user input assembly 14 and/or other buttons or input functionality may be used for additional input and control functions. For instance, special function keys (not shown) may be present. Special function keys may include, for example, a call send and call answer key, a call termination key, multimedia playback control keys, a camera shutter button, navigation keys, a select key, etc. Also, a pointing device may be present. Keys or key-like functionality also may be embodied as a touch screen associated with a display 16. Also, the display 16 may be used in conjunction with a user input device to implement soft key functionality.

The user input assembly 14 includes a touch-sensitive pad 18, such as a capacitive touch pad or a resistive touch pad. In addition, the user input assembly 14 may include a general purpose input/output (GPIO) (not shown) that interprets output signals from the touch-sensitive pad 18 and converts those signals into meaningful input commands or signals for a control assembly of the electronic device 10.

In the illustrated embodiment, the pad 18 forms a contiguous annular ring on a front surface of a housing 20 of the electronic device 10. It will be appreciated that other shapes are possible. The pad 18 may be sensitive to touch of the user, such as when the user touches a finger tip or other item (e.g., a stylus) to the pad 18 or when the user moves a finger tip or other item near the pad 18.

In the illustrated embodiment, the pad 18 is formed apart from the display 16 and takes the place of a conventional keypad that includes discrete buttons. In other embodiments, the user input assembly 14 may be implemented using touch screen technology. In this embodiment, visual characteristics of the pad 18 may be displayed with the display 16 to guide user interaction with user input functionality of the electronic device 10.

In the described and illustrated embodiments, the user input assembly 14 includes a particular arrangement of characters. It will be appreciated that the arrangement of characters may be altered. For example, the order and/or arrangement of characters may be changed, the characters that are shown as part of the user input assembly 14 in the form of labels may be changed, and/or other changes may be made.

In the illustrated embodiment, the user input assembly 14 may be used to enter at least two character sets depending on the operational mode of the electronic device. One operational mode may relate to telephone operation where the user may use the user input assembly 14 to enter numbers for telephone dialing and navigating telephone menus during a telephone call. In this mode, other characters (e.g., the star character and the pound character) may be available. Another operational mode may relate to text entry for composing messages (e.g., instant messages, text messages, multimedia messages, electronic mail messages, etc.), entering contact information, entering internet search criteria or website addresses, and any other text entry operation that may be performed using the electronic device 10.

The pad 18 shows the numbers zero through nine and the star and pound characters. These characters may be made visually apparent to the user. For instance, the characters may be printed on the pad 18 or may be made visible using backlighting. Each location of a character will be referred to as a pad region 22. The illustrated pad regions 22 include pad region 22a that is label with the number one, pad region 22b that is label with the number two, pad region 22c that is label with the number three, pad region 22d that is label with the number four, pad region 22e that is label with the number five, pad region 22f that is label with the number six, pad region 22g that is label with the number seven, pad region 22h that is label with the number eight, pad region 22i that is label with the number nine, pad region 22j that is label with the number zero, pad region 22k that is label with the star symbol, and pad region 22l that is label with the pound (or hash) symbol.

In the telephone operational mode, the user may enter a desired number by touching and releasing the pad region 22 for the corresponding character. For example, if the user would like to enter the number seven, the user may “tap” (e.g., press and then release) the “7” character on the pad 18, which corresponds to pad region 22g. This tapping operation may be a similar gesture to the manner in which the user would press a mechanical push button or a membrane switch.

In the text entry mode, the user input assembly 14 may be used by the user to input characters from a corresponding character set. Characters may be entered by tapping (e.g., touching and releasing) the pad 18 and by movements that are made while touching the pad 18.

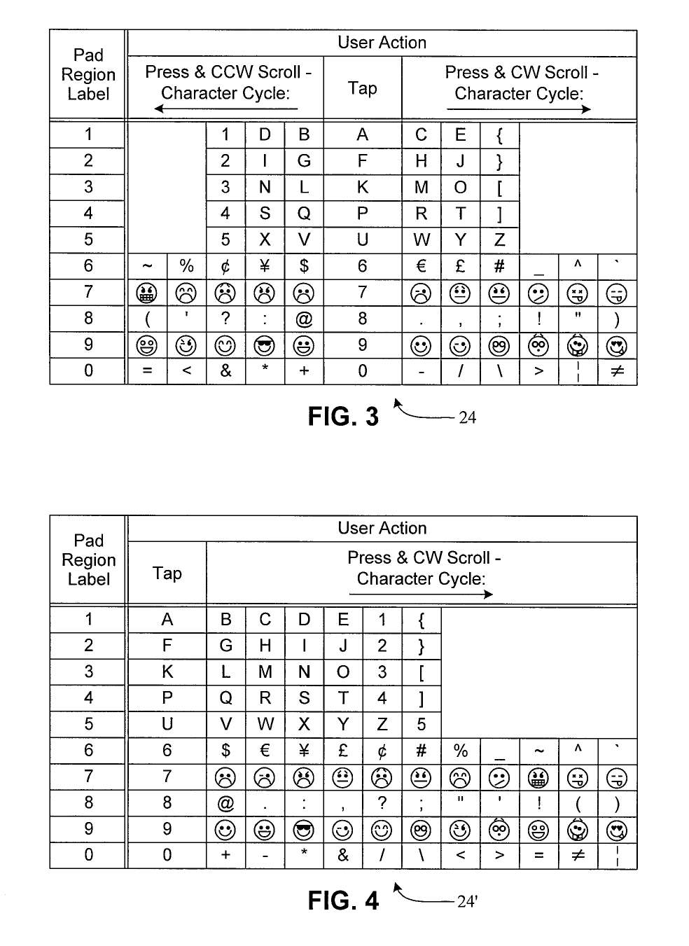

With additional reference to FIG. 3, an exemplary text entry approach will be described. FIG. 3 illustrates a character map 24 that depicts various characters that may be entered in response to corresponding user actions. The user may make predetermined actions (or gestures) to enter a desired character from the character map 24. It will be understood that the character map 24 of FIG. 3 is exemplary. As such, different characters (including English characters, non-English characters, symbols, iconic characters, and so forth) and/or a different arrangement of characters (e.g., a different association of characters to user actions) may be associated with the character map 24.

Each numbered area of the pad 18, or pad regions 22a through 22j, may correspond to plural characters. The gesture made by the user will result in the selection of an individual character from the plural characters corresponding to one of the pad regions 22. The actions include tapping the pad 18 in the location of a user selected one of the pad regions 22 by touching and releasing the pad 18. The actions also include scrolling through characters by touching a user selected one of the pad regions 22, moving in one of the clockwise direction or the counterclockwise direction, and releasing the pad 18.

Using the representative character map 24 of FIG. 3, the association between user action and character entry will be further explained. To assist in guiding the user, indicia 26 that indicate the characters or functions associated with each pad region 22 may be added to the electronic device 10. The indicia 26 may be printed on the housing 20, may appear through the use of backlighting, may be displayed on the display 16, or otherwise made visually apparent to the user. In this manner, the indicia 26 may indicate the types of characters that may be entered using the respective pad regions 22.

A tap of one of the pad regions 22a to 22j will result in entry of a corresponding character from the character map 24. For instance, referring to the tap column of the character map 24, if the user taps the pad region 22a (identified with the pad region label “1”), the character “A” will be entered. Depending on an application undergoing execution by the electronic device 10, there may be a text entry field 28 displayed on the display 16. Entry of a character also may result in display of the character in the text entry field 28.

A dragging motion against the pad 18 may result in scrolling through a predetermined subset of characters from the character map 24. The subset of characters is determined by the pad region 22a to 22j to which initial contact is made. Subsequent motion and then release of contact from the pad 18 may be used to select a character for entry. For example, with continuing reference to the character map 24 of FIG. 3, the user may start by contacting one of the pad regions 22a to 22j, then move in a clockwise (CW) or a counterclockwise (CCW) direction to scroll through characters. As scrolling is made through the characters, a character corresponding to the current position of the user's finger (or other item used to contact the pad 18) may be displayed. To select a character for entry, the user may discontinue contact with the pad 18.

As an example, to enter the character “N”, the user may press the pad region 22c (identified with the pad region label “3”) and move in a counterclockwise direction. Initial counterclockwise movement will result in the display of an “L” and additional counterclockwise movement will result in the display of an “N”. At that point, the user may discontinue contact with the pad 18 to effectuate entry of the “N” character. As another example, to enter an exclamation point (“!”), the user may press the pad region 22h (identified with the pad region label “8”) and move in a clockwise direction. Initial clockwise movement will result in the display of a period (“.”), and additional clockwise movement will result in sequential display of a comma (“,”), a semicolon (“;”) and then the exclamation point. At that point, the user may discontinue contact with the pad 18 to effectuate entry of the exclamation point character.

In one embodiment, movement from one pad region 22 to an immediately adjacent pad region 22 will result in scrolling to the next character in the character map 24. Also, if the user moves too far, the user may reverse direction to scroll “backwards” through the characters associated with the initially touched pad region 22. In addition, the scrolling may be circular in that scrolling past the last illustrated character in the character map 24 may result in advancing to the opposite side of the character map 24. As an example, if the user started with the pad region 22a and scrolled past the character “1”, the character “{” from the opposite side of the character map may be displayed. Subsequent movement may result in display of the letter “E”, then the letter “C′, then the letter “A”, and so forth.

In addition to the characters of the character map 24, designated portions of the pad 18, and/or other buttons or user input devices, may be used for entry of typing commands. For example, the pad region 22k (identified with the pad region label “*”) may be used as a shift key while in the text entry mode. In one embodiment, selection of a letter from the character map 24 will be, by default, an upper case letter for the first letter of a text entry and subsequent letters may be in lower case. But the user may change the case by first tapping the pad region 22k and then selecting a desired letter. The shift between lower and upper case letters may be “locked on” by double tapping of the pad region 22k. When shift is locked on, each subsequent entered letter that would normally be a lower case letter will be entered as an upper case letter, for example.

The pad region 22l (identified with the pad region label “#”) may be used to enter one or more special typographical symbols. For instance, tapping of the pad region 22l may be used to enter a space. Additional typographical symbols that may be entered using the pad region 22l by touching the pad region 22l, moving from the pad region 22l and releasing the pad 18 may include, for example, a backspace (or delete prior character command), a return, a tab and so forth.

In the exemplary embodiment of the character map 24 of FIG. 3, the characters associated with the pad region 22a are A, B, C, D, E, 1 and {. Furthering this example, the characters associated with the pad region 22b are F, G, H, I, J, 2 and }. The characters associated with the pad region 22c are K, L, M, N, O, 3 and [. The characters associated with the pad region 22d are P, Q, R, S, T, 4 and ]. The characters associated with the pad region 22e are U, V, W, X, Y, Z and 5. The characters associated with the pad region 22f relate to the number 6, monetary symbols, and other typographical symbols. The characters associated with the pad region 22g relate to the number 7 and relatively sad and angry emoticons. The characters associated with the pad region 22h relate to the number eight and common punctuation marks. The characters associated with the pad region 22i relate to the number 9 and relatively happy and playful emoticons. The characters associated with the pad region 22j relate to the number zero and common mathematical symbols.

With additional reference to FIG. 4, illustrated is an alternative exemplary character map 24′. The character map 24′ of FIG. 4 is similar to the character map 24 of FIG. 3 in that these two character maps 24 and 24′ associate the same subset of characters with the pad regions 22. The character map 24′, however, orders letters of the English alphabet sequentially when movement is made in the clockwise direction. The characters may be scrolled in reverse order by moving in the counterclockwise direction.

With continued reference to FIGS. 1 and 2, additional features of the electronic device 10 when implemented as a mobile telephone will now be described. As indicated, the electronic device 10 includes the display 16. The display 16 displays information to a user such as telephone numbers and text that has been entered with the user input assembly 14. Also, information such as an operating state, the date and time, contact information, menus, Internet content, received messages, photographs, video, game content, other content may be displayed.

The electronic device 10 includes communications circuitry that enables the electronic device 10 to establish communications with another device. Communications may include calls, data transfers, and the like. Calls may take any suitable form such as, but not limited to, voice calls and video calls. The calls may be carried out over a cellular circuit-switched network or may be in the form of a voice over Internet Protocol (VoIP) call that is established over a packet-switched capability of a cellular network or over an alternative packet-switched network (e.g., a network compatible with IEEE 802.11, which is commonly referred to as WiFi, or a network compatible with IEEE 802.16, which is commonly referred to as WiMAX), for example. Data transfers may include, but are not limited to, receiving streaming content (e.g., streaming audio, streaming video, etc.), receiving data feeds (e.g., pushed data, podcasts, really simple syndication (RSS) data feeds), downloading and/or uploading data (e.g., image files, video files, audio files, ring tones, Internet content, etc.), receiving or sending messages (e.g., text messages, instant messages, electronic mail messages, multimedia messages), and so forth. This data may be processed by the electronic device 10, including storing the data in a memory 30, executing applications to allow user interaction with the data, displaying video and/or image content associated with the data, outputting audio sounds associated with the data, and so forth.

In the exemplary embodiment, the communications circuitry may include an antenna 32 coupled to a radio circuit 34. The radio circuit 34 includes a radio frequency transmitter and receiver for transmitting and receiving signals via the antenna 32. The radio circuit 34 may be configured to operate in a mobile communications system 36. Radio circuit 36 types for interaction with a mobile radio network and/or broadcasting network include, but are not limited to, global system for mobile communications (GSM), code division multiple access (CDMA), wideband CDMA (WCDMA), general packet radio service (GPRS), WiFi, WiMAX, integrated services digital broadcasting (ISDB), high speed packet access (HSPA), etc., as well as advanced versions of these standards or any other appropriate standard. It will be appreciated that the electronic device 10 may be capable of communicating using more than one standard. Therefore, the illustrated antenna 32 and the radio circuit 34 may represent one or more than one radio transceiver assembly.

The system 36 may include a communications network 38 having a server 40 (or servers) for managing calls placed by and destined to the electronic device 10, transmitting data to and receiving data from the electronic device 10 and carrying out any other support functions. The network 38 communicates with the electronic device 10 via a transmission medium. The transmission medium may be any appropriate device or assembly, including, for example, a communications base station (e.g., a cellular service tower, or “cell” tower), a wireless access point, a satellite, etc. The network 38 may support the communications activity of multiple electronic devices 10 and other types of end user devices. As will be appreciated, the server 40 may be configured as a typical computer system used to carry out server functions and may include a processor configured to execute software containing logical instructions that embody the functions of the server 40 and a memory to store such software. In alternative arrangements, the electronic device 10 may wirelessly communicate directly with another electronic device 10 (e.g., another mobile telephone or a computer) through a local network or without an intervening network.

The electronic device 10 may include a primary control circuit 42 that is configured to carry out overall control of the functions and operations of the electronic device 10, including processing signals from the user input assembly 14 and taking appropriate responsive action. The control circuit 42 may include a processing device 44, such as a central processing unit (CPU), microcontroller or microprocessor. The processing device 44 executes code stored in a memory (not shown) within the control circuit 44 and/or in a separate memory, such as the memory 30, in order to carry out operation of the electronic device 10. For instance, the memory within the control circuit 44 and/or the memory 30 may store executable code that embodies the user input function 12 and the processing device 44 may execute that code so that the control circuit 42 is configured to implement the functions of the user input function 12. The memory 30 may be, for example, one or more of a buffer, a flash memory, a hard drive, a removable media, a volatile memory, a non-volatile memory, a random access memory (RAM), or other suitable device. In a typical arrangement, the memory 30 may include a non-volatile memory for long term data storage and a volatile memory that functions as system memory for the control circuit 42. The memory 30 may exchange data with the control circuit 42 over a data bus. Accompanying control lines and an address bus between the memory 30 and the control circuit 42 also may be present.

The electronic device 10 further includes a sound signal processing circuit 46 for processing audio signals. Coupled to the sound processing circuit 46 are a speaker 48 and a microphone 50 that enable a user to listen and speak via the electronic device 10. The radio circuit 34 and sound processing circuit 46 are each coupled to the control circuit 42 so as to carry out overall operation. Audio data may be passed from the control circuit 42 to the sound signal processing circuit 46 for playback to the user. The audio data may include, for example, audio data from an audio file stored by the memory 30 and retrieved by the control circuit 42, or received audio data such as in the form of voice communications. The sound processing circuit 46 may include any appropriate buffers, decoders, amplifiers and so forth.

The display 16 may be coupled to the control circuit 42 by a video processing circuit 52 that converts video data to a video signal used to drive the display 16. The video processing circuit 52 may include any appropriate buffers, decoders, video data processors and so forth.

The electronic device 10 may further include one or more input/output (I/O) interface(s) 54. The I/O interface(s) 54 may be in the form of typical mobile telephone I/O interfaces and may include one or more electrical connectors. The I/O interfaces 54 may form one or more data ports for connecting the electronic device 10 to another device (e.g., a computer) or an accessory (e.g., a personal handsfree (PHF) device) via a cable. Further, operating power may be received over the I/O interface(s) 54 and power to charge a battery of a power supply unit (PSU) 56 within the electronic device 10 may be received over the I/O interface(s) 54. The PSU 56 may supply power to operate the electronic device 10 in the absence of an external power source.

The electronic device 10 also may include various other components. For instance, a camera assembly 58 may be present for taking digital pictures and/or movies. Image and/or video files corresponding to the pictures and/or movies may be stored in the memory 30. A position data receiver 60, such as a global positioning system (GPS) receiver, may be involved in determining the location of the electronic device 10. A local transceiver 62, such as an infrared transceiver and/or an RF transceiver (e.g., a Bluetooth chipset) may be used to establish communication with a nearby device, such as an accessory (e.g., a PHF device), another mobile radio terminal, a computer or another device.

Although certain embodiments have been shown and described, it is understood that equivalents and modifications falling within the scope of the appended claims will occur to others who are skilled in the art upon the reading and understanding of this specification.

What is claimed is:

1. An electronic device, comprising a touch sensitive user input assembly including plural predefined touch regions corresponding to numerical digits for entering digits of a telephone number while the electronic device is in a telephone mode, and in a text entry mode of the electronic device, each touch region is associated with a subset of characters from a character map so that touching and release of one of the touch regions results in entry of a first character from the associated subset of characters, and touching of the touch region followed by moving against the user input assembly results in scrolling through characters of the subset and a scrolled to one of the characters is entered in response to release of touching from the user input assembly.

2. The electronic device of claim 1, wherein there are ten touch regions corresponding to numbers zero through nine for the telephone mode.

3. The electronic device of claim 2, wherein the user input assembly further includes an additional touch region corresponding to a star character in the telephone mode and an additional touch region corresponding to a pound character in the telephone mode.

4. The electronic device of claim 1, wherein the touch regions are arranged in a circular arrangement.

5. The electronic device of claim 4, wherein the moving against the user input assembly includes clockwise movement to scroll through at least a portion of the subset of characters.

6. The electronic device of claim 5, wherein the moving against the user input assembly further includes counterclockwise movement to scroll through at least another portion of the subset of characters.

7. The electronic device of claim 4, wherein the moving against the user input assembly includes counterclockwise movement to scroll through at least a portion of the subset of characters.

8. The electronic device of claim 1, wherein the subset of characters for at least one pad region includes characters that are configured as emoticons.

9. The electronic device of claim 1, wherein the touch sensitive user input assembly includes a touch pad.

10. The electronic device of claim 9, wherein the touch pad is arranged separately from a display of the electronic device.

11. The electronic device of claim 1, wherein, in the text entry mode, an additional one of the touch regions shifts from a default upper or lower case for letter characters to the other of the upper or lower case.

12. The electronic device of claim 1, wherein an additional one of the touch regions corresponds to entry of a space character in the text entry mode.

13. The electronic device of claim 12, wherein the additional one of the touch regions corresponding to entry of a space character further corresponds to entry of at least one of a return, a backspace or a tab.
